(19) United States
(12) Patent Application Publication
(10) Pub. No.: US 2025/0377751 A1
(43) Pub. Date: Dec. 11, 2025

(54) TOUCH PANEL, METHOD FOR CONTROLLING TOUCH PANEL AND NON-TRANSITORY COMPUTER-READABLE RECORDING MEDIUM

(71) Applicant: FCL COMPONENTS LIMITED, Tokyo (JP)

(72) Inventor: Daisuke ICHIKAWA, Tokyo (JP)

(73) Assignee: FCL COMPONENTS LIMITED, Tokyo (JP)

(21) Appl. No.: 19/187,403

(22) Filed: Apr. 23, 2025

(30) Foreign Application Priority Data
Jun. 10, 2024 (JP) 2024-093938

(51) Int. Cl. G06F 3/041; G06F 3/045

(52) U.S. Cl. CPC G06F 3/04186; G06F 3/045; G06F 2203/04104

(57) ABSTRACT

A touch panel includes a first resistive film having a first electrode and a second electrode provided at both ends in a first direction, and a second resistive film having a third electrode and a fourth electrode provided at both ends in a second direction perpendicular to the first direction, wherein the touch panel detects contact between the first resistive film and the second resistive film caused by pressing the first resistive film, and outputs a pressed position. The touch panel further includes a first detector that detects a contact area between the first resistive film and the second resistive film in pressing the first resistive film, a second detector that detects a distance between two points when the two points are pressed on the first resistive film, and a corrector that corrects a detected distance between the two points in accordance with a detected contact area.

### CROSS-REFERENCE TO RELATED APPLICATION

This application is based upon and claims the benefit of priority of the prior Japanese Patent Applications No. 2024-093938 filed on Jun. 10, 2024, the entire contents of which are incorporated herein by reference.

### FIELD

A certain aspect of the embodiments is related to a touch panel, a method for controlling a touch panel and a non-transitory computer-readable recording medium.

### BACKGROUND

There has been known a touch panel that detects a distance between two points in consideration of pressing values of two-point touch. There has been known a touch panel capable of detecting a contact area independent of an input position. Note that the technique related to the present disclosure is disclosed in Japanese Laid-open Patent Publication No. 2011-134316 and Japanese Laid-open Patent Publication No. 2021-179799.

### SUMMARY

According to a first aspect of the present disclosure, there is provided a touch panel including a first resistive film having a first electrode and a second electrode provided at both ends in a first direction, and a second resistive film having a third electrode and a fourth electrode provided at both ends in a second direction perpendicular to the first direction, the touch panel detecting contact between the first resistive film and the second resistive film caused by pressing the first resistive film, and outputting a pressed position. The touch panel further includes a first detector that detects a contact area between the first resistive film and the second resistive film in pressing the first resistive film, a second detector that detects a distance between two points when the two points are pressed on the first resistive film, and a corrector that corrects a detected distance between the two points in accordance with a detected contact area.

### BRIEF DESCRIPTION OF THE DRAWINGS

FIG. 1A is a diagram illustrating a touch panel according to an embodiment of the present embodiment.

FIG. 1B is a functional block diagram illustrating the functions of a CPU.

FIG. 2 is a flowchart illustrating a process of detecting contact point executed by the CPU.

FIG. 3A is a diagram illustrating an equivalent circuit in a case where a voltage measurement unit ADY1 measures a voltage in S5 of FIG. 2.

FIG. 3B is a diagram illustrating an equivalent circuit in a case where a voltage measurement unit ADY2 measures a voltage in S5 of FIG. 2.

FIG. 4 is a diagram illustrating voltages measured by the voltage measurement units ADY1 and ADY2 when a resistance Rs is fixed at 100Ω and resistance values of resistances R1 and R2 are varied.

FIG. 5 is a diagram illustrating an example of two-point input.

FIG. 6 is a graph illustrating a relationship between a distance between two points in an X-axis direction and a voltage measured by a voltage measurement unit ADX1.

FIG. 7 is a flowchart illustrating a process of calculating a contact area at each contact point.

FIG. 8 is a flowchart illustrating a process of calculating a contact area at each contact point.

FIG. 9A is a diagram illustrating press patterns of two points.

FIG. 9B is a diagram illustrating voltage values measured by the voltage measurement units ADX1 and ADX2 in the state of FIG. 9A.

FIG. 9C is a diagram illustrating press patterns of two points.

FIG. 9D is a diagram illustrating voltage values measured by the voltage measurement units ADX1 and ADX2 in the state of FIG. 9C.

FIG. 10A is a diagram illustrating press patterns of two points.

FIG. 10B is a diagram illustrating voltage values measured by the voltage measurement units ADX1 and ADX2 in the state of FIG. 10A.

FIG. 10C is a diagram illustrating press patterns of two points.

FIG. 10D is a diagram illustrating voltage values measured by the voltage measurement units ADX1 and ADX2 in the state of FIG. 10C.

FIG. 11 is a diagram illustrating an example in which a plurality of two-point inputs are displayed on a display device disposed under a touch panel.

FIG. 12 is a diagram illustrating a relationship between a contact area and a distance between two points when the input points of the two-point input of FIG. 11 are pressed.

FIG. 13 is a diagram illustrating a relationship between a contact area and a distance between two points when the input points of the two-point input of FIG. 11 are pressed.

FIG. 14 is a flowchart illustrating a process of correcting a distance between two points in S10 of FIG. 2.

### DESCRIPTION OF EMBODIMENTS

In a touch panel compatible with multi-touch, when two points are touched with a pen tip having a small contact area, the coordinates of the two points at the touch positions are output. On the other hand, when fingers each having a larger contact area than the pen tip touch the two points at the same position, the coordinates of the two points at positions wider than the touch positions of the pen tip are output. This is due to the fact that the distance between two points varies according to the contact area.

The present disclosure provides a touch panel, a method for controlling a touch panel, and a non-transitory computer-readable recording medium, which can suppress a deviation in a distance between two points due to contact areas.

Embodiments of the present disclosure will be described below with reference to the drawings.

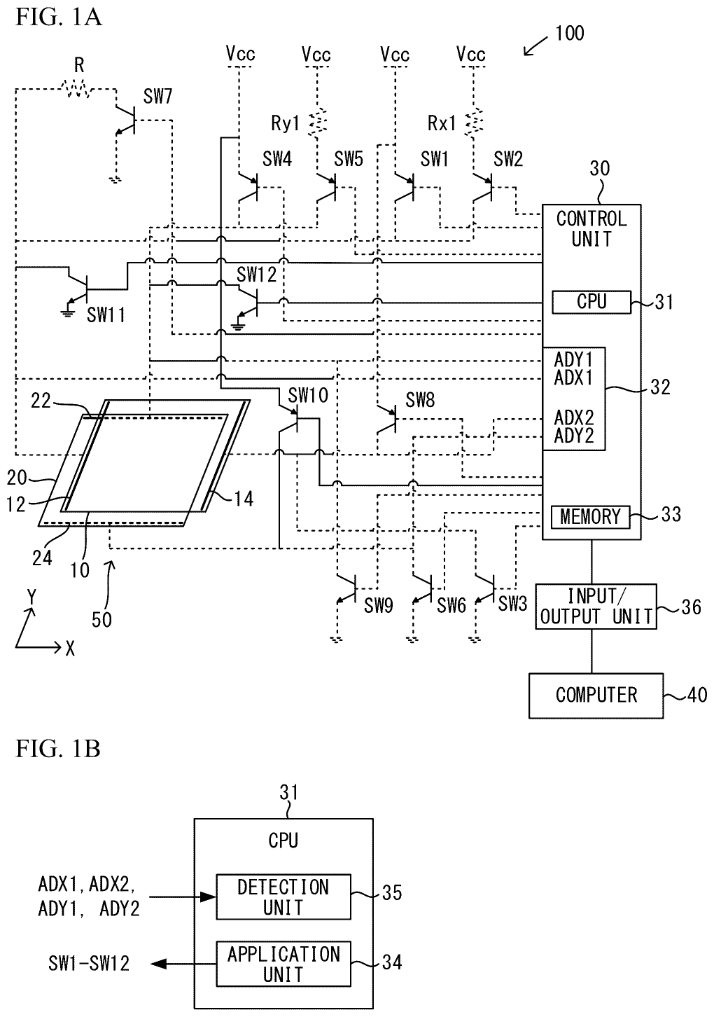

FIG. 1A is a diagram illustrating a touch panel according to the present embodiment. As illustrated in FIG. 1A, a touch panel 100 includes switches SW1 to SW12, resistors R, Rx1 (first voltage dividing resistor), Ry1 (second voltage dividing resistor), resistive films 10 and 20, a control unit 30, and an input/output unit 36. The resistive films 10 and 20 form a touch panel 50 that is a part of the touch panel 100. The resistive film 10 is an upper resistive film, and the resistive film 20 is a lower resistive film. The resistive films 10 and 20 are disposed opposite to each other and overlap a display device (not illustrated) such as a liquid crystal display. An XH electrode 12 (first electrode) is provided on one side of the resistive film 10 (first resistive film), and an XL electrode 14 (second electrode) facing the XH electrode 12 is provided on the other side. A YH electrode 22 (third electrode) is provided on one side of the resistive film 20 (second resistive film), and an YL electrode 24 (fourth electrode) facing the YH electrode 22 is provided on the other side. A direction (X-axis direction) in which the XH electrode 12 and the XL electrode 14 face each other intersects a direction (Y-axis direction) in which the YH electrode 22 and the YL electrode 24 face each other, and the direction (X-axis direction) and the direction (Y-axis direction) are orthogonal to each other in FIG. 1A.

The resistive films 10 and 20 are transparent conductive films formed of, for example, ITO (Indium Tin Oxide). The resistive films 10 and 20 are formed of, for example, the same material, and the electrical resistance is substantially uniformly distributed. The XH electrode 12, the XL electrode 14, the YH electrode 22, and the YL electrode 24 are formed of a metal such as copper or aluminum.

Each of switches SW1 to SW12 is formed of a transistor. The base of the transistor of each switch is connected to the control unit 30. The emitters of the switches SW1, SW4, SW8 and SW10 are connected to a power supply voltage Vcc. The emitter of the switch SW2 is connected to the power supply voltage Vcc through a resistor Rx1. The emitter of the switch SW5 is connected to the power supply voltage Vcc through a resistor Ry1. The emitters of the switches SW3, SW6, SW7, SW9, SW11 and SW12 are grounded. The power supply voltage Vcc is, for example, 5 V.

The XH electrode 12 is connected to the collectors of the switches SW1, SW2 and SW11, and further connected to the collector of the switch SW7 through the resistor R. The XL electrode 14 is connected to the collectors of the switches SW3 and SW8. The YH electrode 22 is connected to collectors of the switches SW4, SW5, SW9 and SW12. The YL electrode 24 is connected to the collectors of the switches SW6 and SW10.

The control unit 30 is connected to a computer 40 as an external device via the input/output unit 36. The touch input data acquired by the control unit 30 is transmitted to the computer 40 via the input/output unit 36. The input/output unit 36 is an interface for transmitting and receiving data between the computer 40 and the control unit 30.

The control unit 30 includes a CPU (Central Processing Unit) 31, an AD converter 32, and a memory 33. The CPU 31 functions as a first detector, a second detector, a measurer, a determiner, a calculator, and a corrector. The AD converter 32 includes voltage measurement units ADX1, ADX2, ADY1, and ADY2. The voltage measurement unit ADX1 is connected to the XH electrode 12, and the voltage measurement unit ADX2 is connected to the XL electrode 14. The voltage measuring portion ADY1 is connected to the YH electrode 22, and the voltage measuring portion ADY2 is connected to the YL electrode 24. The memory 33 stores the voltages measured by the voltage measurement units ADX1, ADX2, ADY1, and ADY2, data necessary for coordinate detection, and the like.

The electric resistance of the resistor Rx1 is substantially the same as the electric resistance of the resistive film 10 between the XH electrode 12 and the XL electrode 14. The electric resistance of the resistor Ry1 is substantially the same as the electric resistance of the resistive film 20 between the YH electrode 22 and the YL electrode 24.

FIG. 1B is a functional block diagram illustrating the functions of the CPU 31. The CPU 31 functions as an application unit 34 and a detection unit 35. The application unit 34 controls voltage application to each electrode by applying voltages to the switches SW1 to SW12 and controlling ON/OFF of the switches SW1 to SW12. The detection unit 35 acquires voltages measured by the voltage measurement units ADX1, ADX2, ADY1, and ADY2, determines whether the pressing is one-point pressing or two-point pressing based on these voltages, and detects the coordinates of a midpoint between two points, the distance between two points, the direction of the line segment connecting the two points, the contact area of each contact point, and the coordinates of each contact point in the case of the two-point pressing.

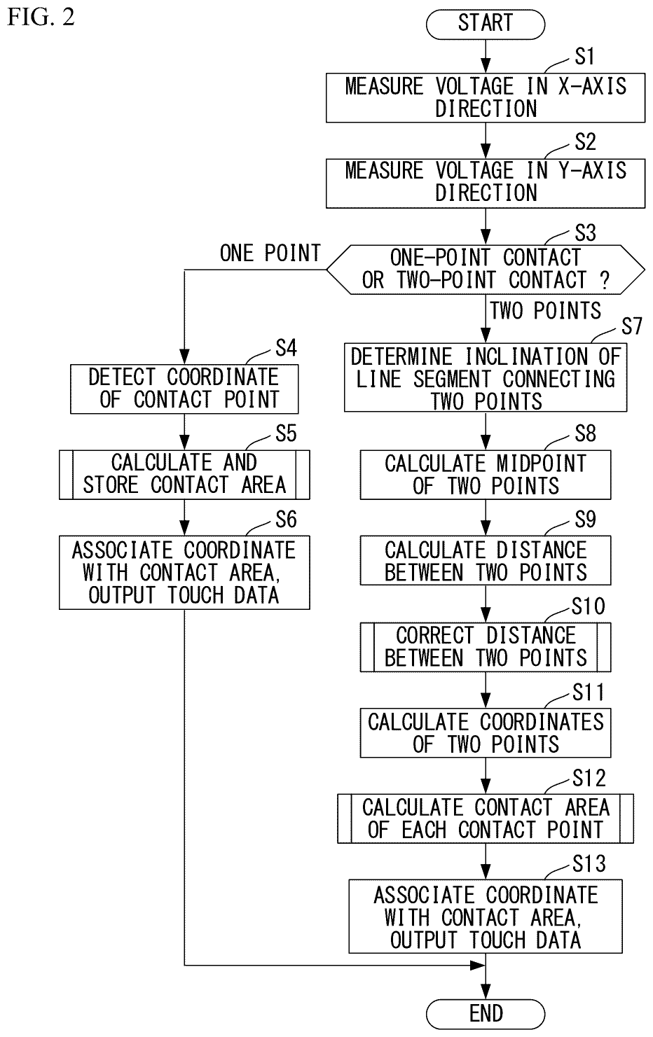

FIG. 2 is a flowchart illustrating a process of detecting the contact point executed by the CPU 31.

First, the CPU 31 measures the voltage in the X-axis direction (S1). Specifically, the CPU 31 turns on the switches SW2 and SW3 and turns off the other switches, and the voltage measurement unit ADX1 measures a voltage. In this state, the XH electrode 12 is at a high potential, and the XL electrode 14 is at a low potential. The power supply voltage Vcc is applied to the XH electrode 12 through the resistor Rx1, and the XL electrode 14 is grounded, so that a potential distribution is generated in the X-axis direction of the resistive film 10. In this state, the voltage is measured by the voltage measurement unit ADX1, and the measured voltage is stored in the memory 33. The voltage (first direction voltage) measured by the voltage measurement unit ADX1 is a value obtained by dividing the power supply voltage by the resistance Rx1 and a resistance component between the XH electrode 12 and the XL electrode 14.

Next, the voltage in the Y-axis direction is measured (S2). Specifically, the CPU 31 turns on the switches SW5 and SW6, and turns off the other switches, and the voltage measuring section ADY1 measures a voltage. In this state, the YH electrode 22 is at a high potential, and the YL electrode 24 is at a low potential. The power supply voltage Vcc is applied to the YH electrode 22 through the resistor Ry1, and the YL electrode 24 is grounded, so that a potential distribution is generated in the Y-axis direction of the resistive film 20. In this state, the voltage is measured by the voltage measurement unit ADY1, and the measured voltage is stored in the memory 33. The voltage (second direction voltage) measured by the voltage measurement unit ADY1 is a value obtained by dividing the power supply voltage by the resistance Ry1 and a resistance component between the YH electrode 22 and the YL electrode 24.

Next, the CPU 31 determines whether the contact point is one point or two points (S3). Specifically, it is determined whether the voltage measured by the voltage measurement unit ADX1 in S1 and the voltage measured by the voltage measurement unit ADY1 in S2 are Vcc/2 or less than Vcc/2. When both the voltage measured by the voltage measurement unit ADX1 and the voltage measured by the voltage measurement unit ADY1 are Vcc/2, the CPU 31 determines that the contact point is one point. On the other hand, when both the voltage measured by the voltage measurement unit ADX1 and the voltage measured by the voltage measurement unit ADY1 are less than Vcc/2, the CPU 31 determines that the contact point is two points.

If it is determined in S3 that the contact point is one point, the CPU 31 detects the coordinates of the contact point by a normal position detection method (S4). The CPU 31 turns on the switches SW1 and SW3, turns off the other switches, and detects the X coordinate of the contact point based on the voltage measured by the voltage measurement unit ADY1 or ADY2. At this time, the CPU 31 calculates the distance from the XH electrode 12 to the contact point in the X-axis direction by multiplying the ratio of the voltage measured by the voltage measurement unit ADY1 or ADY2 to the potential difference between the XH electrode 12 and the XL electrode 14 by the distance between the XH electrode 12 and the XL electrode 14. Further, the CPU 31 turns on the switches SW4 and SW6, turns off the other switches, and detects the Y coordinate of the contact point based on the voltage measured by the voltage measurement unit ADX1 or ADX2. Here, the CPU 31 calculates the distance from the YH electrode 22 to the contact point in the Y-axis direction by multiplying the distance between the YH electrode 22 and the YL electrode 24 by the ratio of the voltage measured by the voltage measurement unit ADX1 or ADX2 to the potential difference between the YH electrode 22 and the YL electrode 24.

Next, the CPU 31 turns on the switches SW1, SW6, and SW8, and turns off the other switches, and the voltage measurement unit ADY1 measures a voltage. Subsequently, the CPU 31 turns on the switches SW1, SW8, and SW12, and turns off the other switches, and the voltage measurement unit ADY2 measures a voltage. The CPU 31 stores the total value of the voltage measured by the voltage measurement unit ADY1 and the voltage measured by the voltage measurement unit ADY2 in the memory 33 (S5). Since the total value stored in the memory 33 is correlated with the contact area between the resistive films 10 and 20, the relative magnitude relationship of the contact area can be obtained using the total value.

In the above description, the total value of the voltage measured by the voltage measurement unit ADY1 and the voltage measured by the voltage measurement unit ADY2 is set as the contact area of the contact point, but the total value of the voltage measured by the voltage measurement unit ADX1 and the voltage measured by the voltage measurement unit ADX2 may be set as the contact area of the contact point. In this case, the CPU 31 turns on the switches SW3, SW4 and SW10, and turns off the other switches, and the voltage measurement unit ADX1 measures a voltage. Subsequently, the CPU 31 turns on the switches SW4, SW10 and SW11, and turns off the other switches, and the voltage measurement unit ADX2 measures a voltage.

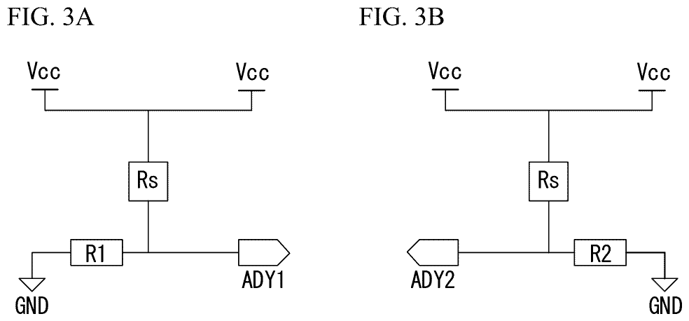

FIG. 3A is a diagram illustrating an equivalent circuit in a case where the voltage measurement unit ADY1 measures a voltage in S5. FIG. 3B is a diagram illustrating an equivalent circuit in a case where the voltage measurement unit ADY2 measures a voltage in S5. In FIGS. 3A and 3B, “Rs” represents a resistance between the resistive films 10 and 20 at the contact point, “R1” represents a resistance from the contact point to the YL electrode 24, and “R2” represents a resistance from the contact point to the YH electrode 22. The resistance Rs depends on the contact area of the resistive film 10 and the resistive film 20, the resistance R1 depends on a distance between the contact point and the YL electrode 24, and the resistance R2 depends on a distance between the contact point and the YH electrode 22.

When the input position is the same, the resistance R1 is constant, and the measured voltage of the voltage measurement unit ADY1 is proportional to the contact area of the contact point, so that the contact area can be estimated. However, when the input position changes, the value of the resistor R1 also changes. Therefore, the electrodes to be grounded are replaced by the YH electrode 22 and the YL electrode 24, and the voltages are measured by the respective voltage measurement units, and the voltages measured by the voltage measurement unit ADY1 and the voltages measured by the voltage measurement unit ADY2 are summed up. By using the sum as the contact area, the variation of the calculation result of the contact area due to the difference in the input position is suppressed, and the contact area can be detected independently of the input position.

The measured voltages of the voltage measurement units ADY1 and ADY2 are calculated by the following equation.

$$\begin{matrix}ADY 1 = Vcc \times R 1 / ( Rs + R 1 ) \\ ADY 2 = Vcc \times R 2 / ( Rs + R 2 )\end{matrix}$$

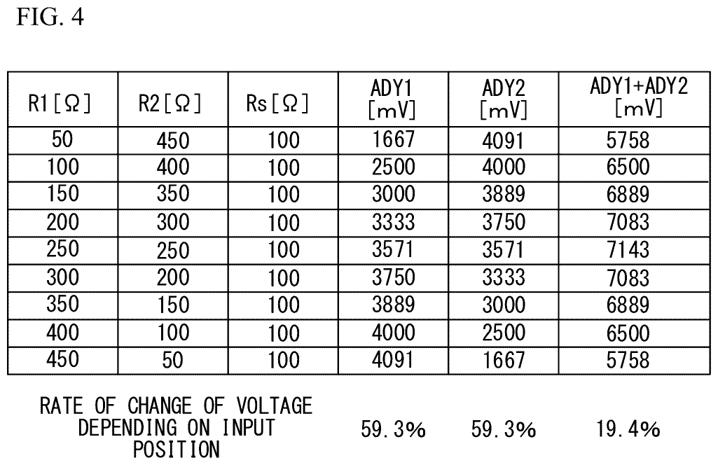

For example, FIG. 4 illustrates an example of voltages measured by the voltage measurement units ADY1 and ADY2 when the resistance Rs corresponding to the contact area is fixed to 100Ω and the resistances R1 and R2 are changed.

The maximum value of the voltage values measured by the voltage measurement units ADY1 and ADY2 is 4091 mV, and the minimum value thereof is 1667 mV. Therefore, the rate of change of the voltage measured by either the voltage measurement unit ADY1 or ADY2 depending on the input position is 59.3% (=(4091−1667)/4091×100%). Accordingly, when the voltage is measured by only one of the voltage measurement units ADY1 and ADY2, it is understood that the measured voltage value, that is, the variation in the contact area due to the difference in the input position is large.

On the other hand, the maximum value of the total of the voltage values measured by the voltage measurement units ADY1 and ADY2 is 7143 mV, and the minimum value thereof is 5758 mV. Therefore, when the voltages are measured by both the voltage measurement units ADY1 and ADY2, the rate of change of the voltages depending on the input position is 19.4% (=(7143-5758)/7143×100%). Accordingly, it is understood that the variation of the contact area due to the difference in the input position can be suppressed by using the total value of the voltage values measured by both the voltage measurement units ADY1 and ADY2.

Referring back to FIG. 2, the CPU 31 generates touch data by associating the coordinates of the contact point detected in S4 with the contact area measured in S5, and outputs the touch data to the computer 40 via the input/output unit 36 (S6), and then ends the present process.

On the other hand, if it is determined in S3 that the contact point is two points, the CPU 31 determines whether the inclination of the line segment connecting the two points is parallel to the X-axis direction or the Y-axis direction, or is in an oblique direction (S7).

Prior to the processing of FIG. 2, as an initial processing, the switches SW2 and SW3 are turned on in a state where the contact point is 0 or 1 point, and the other switches are turned off, and the voltage is measured in advance by the voltage measurement unit ADX1 in a state where the potential distribution is formed in the X-axis direction of the resistive film 10. The CPU 31 stores the voltage measured by the voltage measurement unit ADX1 in this state as an initial voltage al in the memory 33. Similarly, the switches SW5 and SW6 are turned on in a state where the contact point is 0 or 1 point, and the other switches are turned off, thereby forming the potential distribution in the Y-axis direction of the resistive film 20, and the voltage is measured in advance by the voltage measurement unit ADY1. The CPU 31 stores the voltage measured by the voltage measurement unit ADY1 in this state as an initial voltage α2 in the memory 33. Such setting of the initial voltage can be performed at an appropriate timing, for example, when the apparatus is started to be used, when the apparatus is manufactured, or the like.

In S7, the CPU 31 compares the voltages measured in S1 and S2 with the stored initial voltages α1 and α2, and thereby determines whether the line segment connecting the two points is parallel to the X-axis direction, parallel to the Y-axis direction, or oblique to the X-axis direction and the Y-axis direction.

When the voltage measured in S1 is lower than the initial voltage al and the voltage measured in S2 is substantially equal to the initial voltage α2, the CPU 31 determines that the line segment connecting the two points is parallel to the X-axis direction. If the voltage measured in S1 is substantially the same as the initial voltage al and the voltage measured in S2 is lower than the initial voltage α2, the CPU 31 determines that the line segment connecting the two points is parallel to the Y-axis direction. Furthermore, when the voltage measured in S1 is lower than the initial voltage al and the voltage measured in S2 is lower than the initial voltage α2, the CPU 31 determines that the line segment connecting the two points is in the oblique direction.

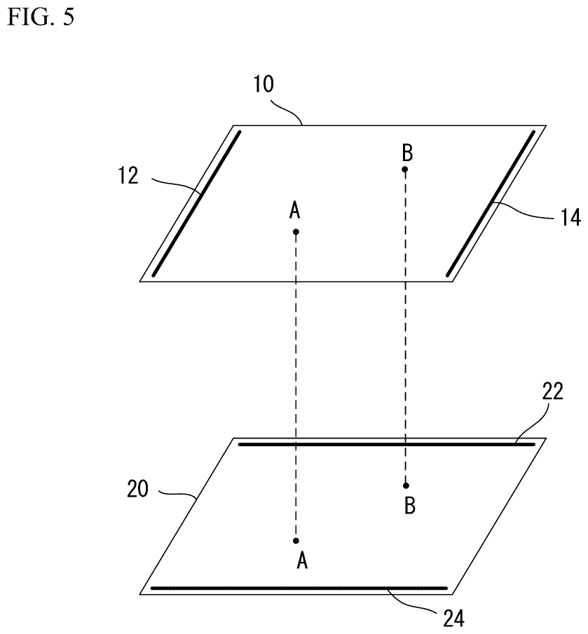

In order to determine whether the inclination of the line segment connecting the two points of a point A and a point B is in a rightward-ascending direction or a rightward-descending direction as illustrated in FIG. 5, the CPU 31 turns on the switches SW1 and SW3 and turns off the other switches to form the potential distribution in the X-axis direction of the resistive film 10, and the voltage measurement units ADY1 and ADY2 measure the voltage. When the voltage measured by the voltage measurement unit ADY1 is lower than the voltage measured by the voltage measurement unit ADY2, the CPU 31 determines that the inclination of the line segment connecting the two points is the rightward-ascending-direction. When the voltage measured by the voltage measurement unit ADY1 is higher than the voltage measured by the voltage measurement unit ADY2, the CPU 31 determines that the inclination of the line segment connecting the two points is a leftward-ascending-direction.

Next, the CPU 31 calculates the coordinates of the midpoint of the two points (S8). Specifically, the CPU 31 turns on the switches SW1 and SW3 and turns off the other switches to form the potential distribution in the X-axis direction of the resistive film 10, and the voltage measurement units ADY1 and ADY2 measure the voltage. The CPU 31 acquires the voltage in the X-axis direction by calculating an average value of the voltages measured by the voltage measurement unit ADY1 and the voltage measured by the voltage measurement unit ADY2, and acquires the X coordinate of the midpoint based on the acquired voltage. For example, the CPU 31 acquires the distance from the XH electrode 12 in the X-axis direction by multiplying the distance between the XH electrode 12 and the XL electrode 14 by the ratio of the potential difference between the XH electrode 12 and the XL electrode 14 to the calculated average value.

Similarly, the CPU 31 turns on the switches SW4 and SW6 and turns off the other switches to form the potential distribution in the Y-axis direction of the resistive film 20, and the voltage measurement units ADX1 and ADX2 measure the voltage. The CPU 31 acquires the Y coordinate of the midpoint based on the average value of the voltage measured by the voltage measurement unit ADX1 and the voltage measured by the voltage measurement unit ADX2. For example, the CPU 31 multiplies the distance between the YH electrode 22 and the YL electrode 24 by the ratio of the potential difference between the YH electrode 22 and the YL electrode 24 to the calculated average value, thereby acquiring the distance from the YH electrode 22 in the Y-axis direction.

Referring back to FIG. 2, the CPU 31 calculates the distance between two points (S9). Specifically, the distance between two points is calculated based on the voltages measured in S1 and S2.

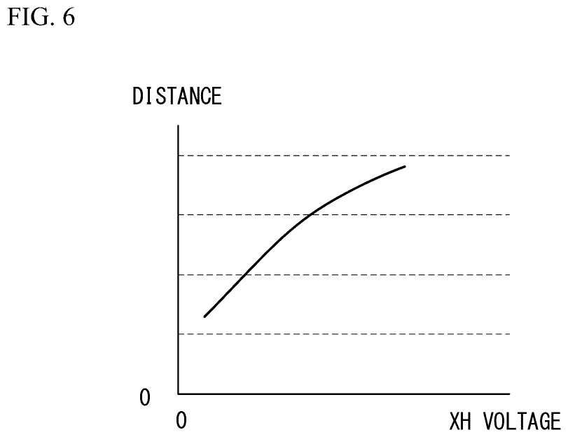

FIG. 6 illustrates a relationship between the distance between two points in the X-axis direction and the voltage measured by the voltage measurement unit ADX1, and the relationship of FIG. 6 is used as distance calculation data. The distance calculation data is stored in the memory 33.

As illustrated in FIG. 6, the value of the measured voltage increases as the distance between two points increases.

The distance between two points in the X-axis direction is obtained based on the relationship between the distance between two points illustrated in FIG. 6 and the voltage measured by the voltage measurement unit ADX1.

The memory 33 also includes the distance calculation data indicating the relationship between the distance between two points in the Y-axis direction and the voltage measured by the voltage measurement unit ADY1. The CPU 31 obtains the distance between two points in the Y-axis direction based on the distance calculation data indicating the relationship between the distance between two points in the Y-axis direction and the voltage measured by the voltage measurement unit ADY1 and the voltage measured by the voltage measurement unit ADY1, in a manner similar to the method for obtaining the distance between two points in the X-axis direction.

Referring back to FIG. 2, the CPU 31 executes a process of correcting the distance between two points calculated in S9 (S10). The details of the process of correcting the distance between two points in S10 will be described later. The distance between two points after S10 is a distance between two points corrected in S10.

Next, the CPU 31 calculates the coordinates of the two points (S11). The CPU 31 calculates the coordinates of each of the two points based on the position of the midpoint of the two points and the distance between two points.

Specifically, when the distance between two points in the X-axis direction is calculated as Lx, the distance between two points in the Y-axis direction is calculated as Ly, and the midpoint coordinates of the two points are (Xc, Yc), the coordinates of the two points are expressed by any of the following equations (1) to (4). Note that Equation (1) indicates a case where the two points are on a rightward-ascending straight line, Equation (2) indicates a case where the two points are on a leftward-ascending straight line, Equation (3) indicates a case where the two points are on a straight line in the X-axis direction, and Equation (4) indicates a case where the two points are on a straight line in the Y-axis direction.

$$( X c + Lx / 2 , Yc + Ly / 2 ) , ( X c - Lx / 2 , Yc - Ly / 2 ) \qquad ( 1 )$$

$$( Xc + Lx / 2 , Y c - Ly / 2 ) , ( X c - Lx / 2 , Y c + Ly / 2 ) \qquad ( 2 )$$

$$( Xc + Lx / 2 , Yc ) , ( Xc - Lx / 2 , Yc ) \qquad ( 3 )$$

$$( Xc , Yc + Ly / 2 ) , ( Xc , Yc - Ly / 2 ) \qquad ( 4 )$$

Next, the CPU 31 calculates the contact area at each contact point (S12). A process of calculating the contact area will be described in detail later.

Next, the CPU 31 generates touch data in which the coordinates of the two points calculated in step S11 and the contact area at each contact point calculated in step S12 are associated with each other, and outputs the touch data to the computer 40 via the input/output unit 36 (S13), and ends the process of FIG. 2.

By this processing, the computer 40 that received the touch data can determine a magnitude relationship between the contact areas of the two contact points.

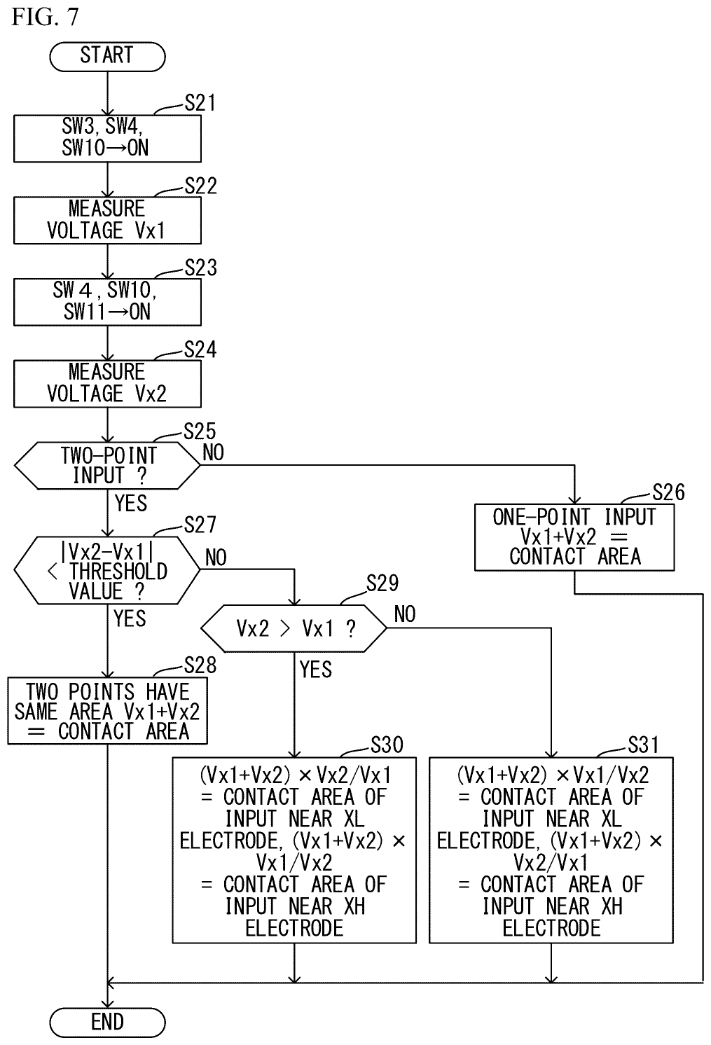

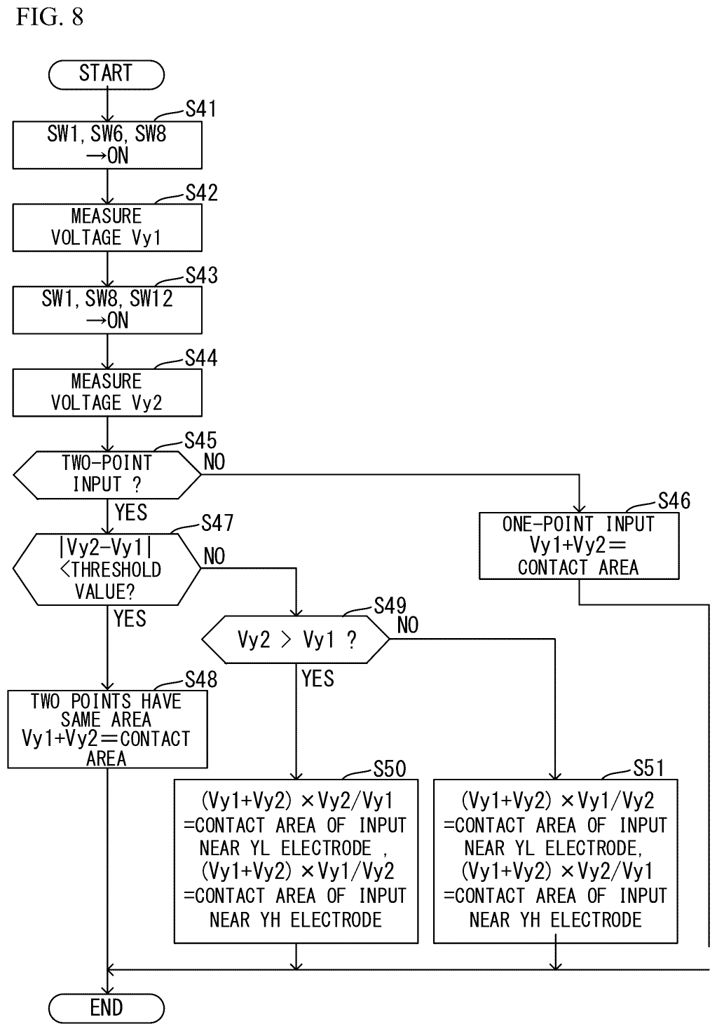

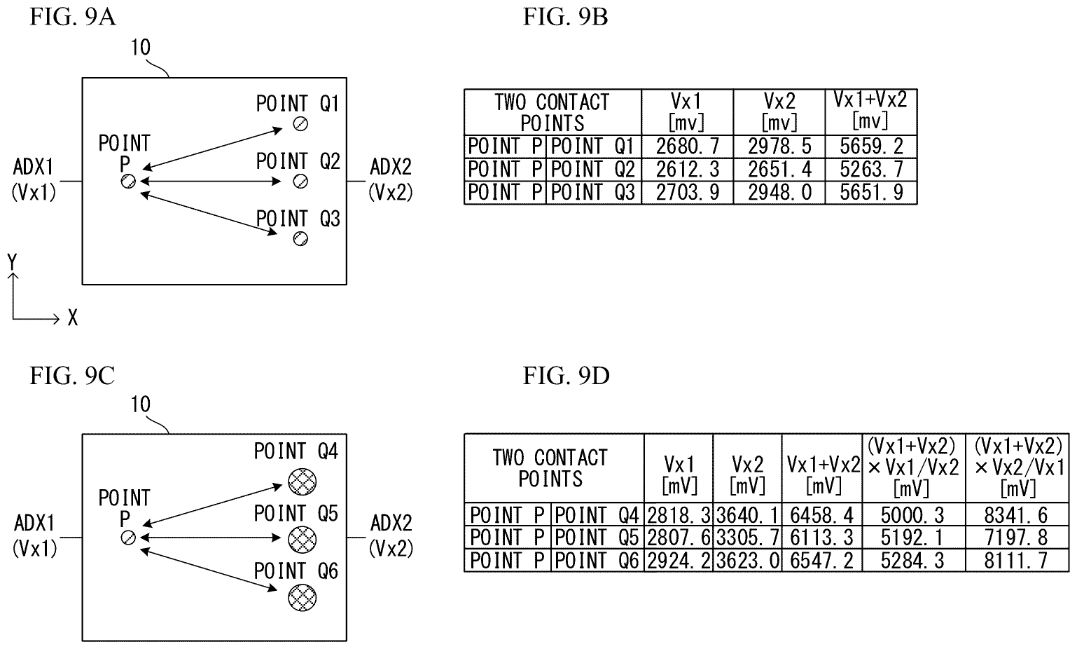

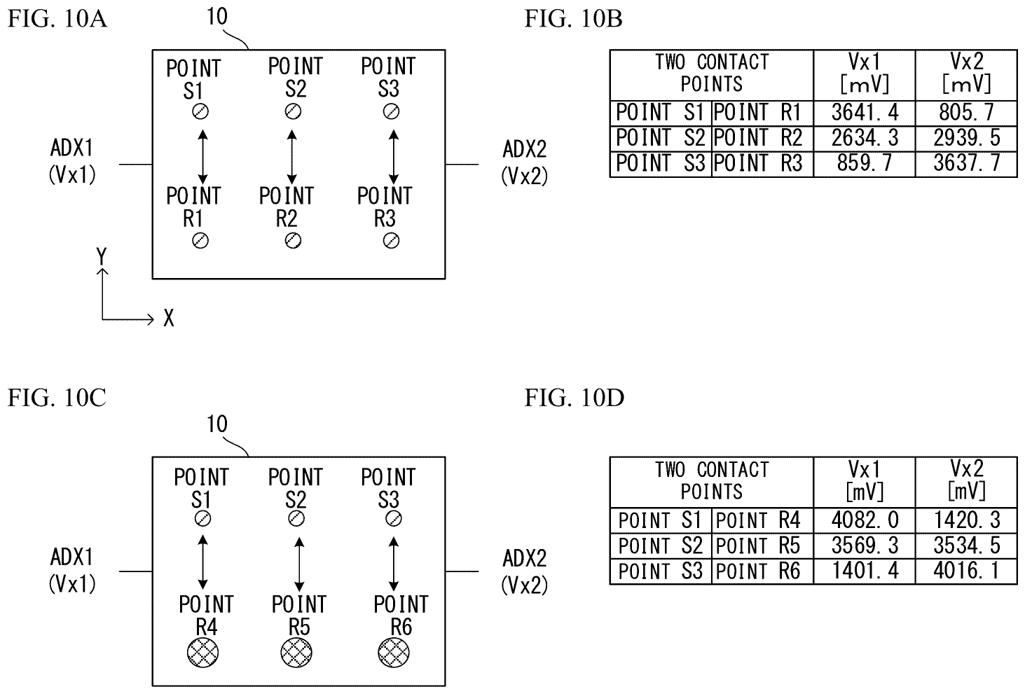

FIGS. 7 and 8 are flowcharts illustrating the process of calculating the contact area at each contact point. FIG. 9A is a diagram illustrating press patterns of the two points. FIG. 9B is a diagram illustrating voltage values measured by the voltage measurement units ADX1 and ADX2 in the state of FIG. 9A. FIG. 9C is a diagram illustrating press patterns of the two points. FIG. 9D is a diagram illustrating voltage values measured by the voltage measurement units ADX1 and ADX2 in the state of FIG. 9C. FIG. 10A is a diagram illustrating press patterns of the two points. FIG. 10B is a diagram illustrating voltage values measured by the voltage measurement units ADX1 and ADX2 in the state of FIG. 10A. FIG. 10C is a diagram illustrating press patterns of the two points. FIG. 10D is a diagram illustrating voltage values measured by the voltage measurement units ADX1 and ADX2 in the state of FIG. 10C.

FIG. 7 illustrates a process executed by the CPU 31 when the line segment connecting the two points is parallel or oblique to the X-axis direction, and FIG. 8 illustrates a process executed by the CPU 31 when the line segment connecting the two points is parallel or oblique to the Y-axis direction.

In S7 of FIG. 2, it is determined whether the line segment connecting the two points is parallel to the X-axis direction, parallel to the Y-axis direction, or oblique to the X-axis direction and the Y-axis direction, and since the input coordinates of the two points are known in the process of S11 of FIG. 2, the CPU 31 can determine the state of the line segment connecting the two points before the process of calculating the contact area. Accordingly, the CPU 31 selects either the process of FIG. 7 or the process of FIG. 8 to execute based on the process result of S7 or S11 of FIG. 2.

Hereinafter, the voltage measured by the voltage measurement unit ADX1 is referred to as a voltage Vx1, and the voltage measured by the voltage measurement unit ADX2 is referred to as a voltage Vx2.

In FIG. 7, the CPU 31 turns on the switches SW3, SW4, and SW10, and turns off the other switches (S21), and the voltage measurement unit ADX1 measures the voltage Vx1 (S22). Since the switches SW4 and SW10 are turned on, the power supply voltage Vcc is applied uniformly to the entire resistive film 20. In this way, when calculating the contact area, the potential applied to the entire resistance film on a voltage application side is made uniform. This is because, when the potential distribution is formed in the resistance film on the voltage application side, the voltage measured by the voltage measuring section varies depending on the position of the two-point input, and the contact area cannot be appropriately detected.

Subsequently, the CPU 31 turns on the switches SW4, SW10, and SW11, and turns off the other switches (S23), and the voltage measurement unit ADX2 measures the voltage Vx2 (S24). Since the switches SW4 and SW10 are also turned ON in this case, the power supply voltage Vcc is applied uniformly to the entire resistive film 20.

The CPU 31 determines whether the contact point is two points (S25), as in S3 of FIG. 2. If the contact point is one point (NO in S25), the CPU 31 stores the total value of the voltages Vx1 and Vx2 in the memory 33 as the contact area of the contact point (S26), and ends the process.

If the contact point is two points (YES in S25), it is determined whether the difference between the voltage Vx2 and the voltage Vx1 is less than a threshold value (for example, 300 mV) (S27). In S27, it is determined whether the contact areas of the two points are substantially the same as each other.

For example, in FIG. 9A, both a point P and points Q1 to Q3 indicate contact points with the pen tip. In this case, it is expected that the contact area at the time of pressing the point P and the contact area at the time of pressing the points Q1 to Q3 are the same or substantially the same as each other. As two-point press patterns, three patterns, i.e., a press pattern of the points P and Q1, a press pattern of the points P and Q2, and a press pattern of the points P and Q3 are illustrated. In all cases, as illustrated in FIG. 9B, the difference between voltages Vx2 and Vx1 is, for example, less than 300 mV.

On the other hand, in FIG. 9C, the point P indicates the contact point with the pen tip, and points Q4 to Q6 indicate contact points with the fingertips. The contact area between the points Q4 to Q6 is larger than the contact area of the point P. As two-point press patterns, three patterns, i.e., a press pattern of the points P and Q4, a press pattern of the points P and Q5, and a press pattern of the points P and Q6 are illustrated. In all cases, as illustrated in FIG. 9D, the difference between voltages Vx2 and Vx1 is, for example, 300 mV or more.

Referring back to FIG. 7, when the differential between the voltages Vx2 and Vx1 is less than the threshold (YES in S27), the CPU 31 stores the total value of the voltages Vx2 and Vx1 in the memory 33 as the contact area of each point of the two-point input (S28), and ends the process. For example, a total value of 5659.2 mV illustrated in FIG. 9B is assigned to the points P and Q1 in FIG. 9A as the voltage corresponding to the contact area.

When the difference between the voltage Vx2 and the voltage Vx1 is equal to or greater than the threshold value (NO in S27), the CPU 31 determines whether the voltage Vx2 is greater than the voltage Vx1 (S29). Here, it is determined which of the two input points has a larger contact area.

If the voltage Vx2 is greater than the voltage Vx1 (YES in S29), the CPU 31 sets a value (=(Vx1+Vx2)×Vx2/Vx1), which is obtained by multiplying the ratio of the voltage Vx2 to the voltage Vx1 by the total value of the voltage Vx1 and the voltage Vx2, as the contact area of the input point near the XL electrode 14, and sets a value (=(Vx1+Vx2)×Vx1/Vx2), which is obtained by multiplying the ratio of the voltage Vx1 to the voltage Vx2 by the total value of the voltage Vx1 and the voltage Vx2, as the contact area of the input point near the XH electrode 12 (S30), and then ends the process. For example, 5000.3 mV and 8341.6 mV illustrated in FIG. 9D are respectively assigned to the points P and Q4 illustrated in FIG. 9C as voltages corresponding to the contact areas.

If the voltage Vx1 is greater than the voltage Vx2 (NO in step S29), the CPU 31 sets a value (=(Vx1+Vx2)×Vx1/Vx2), which is obtained by multiplying the ratio of the voltage Vx1 to the voltage Vx2 by the total value of the voltage Vx1 and the voltage Vx2 as the contact area of the input point near the XH electrode 12, and sets a value (=(Vx1+Vx2)×Vx2/Vx1), which is obtained by multiplying the ratio of the voltage Vx2 to the voltage Vx1 by the total value of the voltage Vx1 and the voltage Vx2 as the contact area of the input point near the XL electrode 14 (S31), and then ends the process.

As described above, in the process of calculating the contact area, in both the case of the one-point input and the case of the two-point input, as illustrated in S26, S28, S30, and S31, the total value of the voltage Vx1 measured by the voltage measurement unit ADX1 and the voltage Vx2 measured by the voltage measurement unit ADX2 is used, whereby the variation of the contact area due to the difference in the input position is suppressed, and the contact area independent of the input position is detected.

As illustrated in FIGS. 9B and 9D, when the voltages Vx1 and Vx2 are measured, even if the total value of the voltages Vx1 and Vx2 is used, the total value varies depending on the input position. In order to suppress the variation, for example, the CPU 31 may correct the values of the voltages Vx1 and Vx2 by using a correction coefficient predetermined in accordance with the input position, thereby suppressing the variation in the total value of the voltages Vx1 and Vx2 due to the difference in the input position.

In FIG. 10A, the points S1 to S3 and the points R1 to R3 are all contact points with the pen tip. The contact areas of the points S1 to S3 and the points R1 to R3 are the same as each other. As two-point press patterns, three patterns, i.e., a press pattern of the points S1 and R1, a press pattern of the points S2 and R2, and a press pattern of the points S3 and R3 are illustrated. As illustrated in FIG. 10B, the values of the voltages Vx1 and Vx2 vary greatly depending on the input position in the range of 3641.4 mV to 805.7 mV.

In FIG. 10C, the points S1 to S3 indicate contact points with the pen tip, and the points R4 to R6 indicate contact points with the fingertip. The contact area when each of the points R4 to R6 is pressed is larger than the contact area when each of the points S1 to S3 is pressed. As two-point press patterns, three patterns, i.e., a press pattern of the points S1 and R4, a press pattern of the points S2 and R5, and a press pattern of the points S3 and R6 are illustrated. In this case, as illustrated in FIG. 10D, the values of the voltages Vx1 and Vx2 vary greatly depending on the input position in the range of 4082.0 mV to 1401.4 mV.

The process of calculating the contact area illustrated in FIG. 7 cannot be used when the line segment connecting the two points is parallel to the Y-axis direction as illustrated in FIGS. 10A and 10C. The reason why the process of calculating the contact area cannot be used is that the values of the voltages Vx1 and Vx2 greatly vary depending on the position of the input, and the contact area to be obtained also greatly varies, as illustrated in FIGS. 10B and 10D. Therefore, as described above, when the line segment connecting the two points is parallel to the Y-axis direction as illustrated in FIGS. 10A and 10C, the process of calculating the contact area of FIG. 8 is used.

The process of calculating the contact area illustrated in FIG. 8 will be described below. The voltage measured by the voltage measurement unit ADY1 is referred to as a voltage Vy1, and the voltage measured by the voltage measurement unit ADY2 is referred to as a voltage Vy2.

In FIG. 8, the CPU 31 turns on the switches SW1, SW6, and SW8, and turns off the other switches (S41), and the voltage measurement unit ADY1 measures the voltage Vy1 (S42). Since the switches SW1 and SW8 are turned on, the power supply voltage Vcc is applied uniformly to the entire resistive film 10.

Subsequently, the CPU 31 turns on the switches SW1, SW8, and SW12, and turns off the other switches (S43), and the voltage measurement unit ADY2 measures the voltage Vy2 (S44). Since the switches SW1 and SW8 are also turned ON in this case, the power supply voltage Vcc is uniformly applied to the entire resistive film 10.

The CPU 31 determines whether the contact point is two points (S45), as in S3 of FIG. 2. If the contact point is one point (NO in S45), the CPU 31 stores the total value of the voltages Vy1 and Vy2 in the memory 33 as the contact area of the contact point (S46), and ends the process.

If the contact point is two points (YES in S45), it is determined whether the difference between the voltage Vy2 and the voltage Vy1 is less than a threshold value (for example, 300 mV) (S47). Here, it is determined whether the contact areas of the two points are substantially the same as each other.

If the difference between the voltage Vy2 and the voltage Vy1 is less than the threshold value (YES in S47), the CPU 31 stores the total value of the voltage Vy2 and the voltage Vy1 in the memory 33 as the contact area of each of the two input points (S48), and ends the process.

When the difference between the voltage Vy2 and the voltage Vy1 is equal to or greater than the threshold value (NO in S47), the CPU 31 determines whether the voltage Vy2 is greater than the voltage Vy1 (S49). In this case, it is determined which of the two input points has a larger contact area.

If the voltage Vy2 is greater than the voltage Vy1 (YES in S49), the CPU 31 sets a value (=(Vy1+Vy2)×Vy2/Vy1), which is obtained by multiplying the ratio of the voltage Vy2 to the voltage Vy1 by the total value of the voltage Vy1 and the voltage Vy2, as the contact area of the input point near the YL electrode 24, and sets a value (=(Vy1+Vy2)×Vy1/Vy2), which is obtained by multiplying the ratio of the voltage Vy1 to the voltage Vy2 by the total value of the voltage Vy1 and the voltage Vy2, as the contact area of the input point near the YH electrode 22 (S50), and then ends the process.

If the voltage Vy1 is greater than the voltage Vy2 (NO in S49), the CPU 31 sets a value (=(Vy1+Vy2)×Vy1/Vy2), which is obtained by multiplying the ratio of the voltage Vy1 to the voltage Vy2 by the total value of the voltage Vy1 and the voltage Vy2, as the contact area of the input point near the YH electrode 22, and sets a value (=(Vy1+Vy2)×Vy2/Vy1), which is obtained by multiplying the ratio of the voltage Vy2 to the voltage Vy1 by the total value of the voltage Vy1 and the voltage Vy2, as the contact area of the input point near the YL electrodes 24 (S51), and then ends the process.

The contact area calculated in the processing of FIGS. 7 and 8 can be applied to an application in which the operation is changed depending on the size of the contact area at each input point. For example, the contact area calculated in the processing of FIGS. 7 and 8 can be applied to (1) an application displaying a button for determining that an input with a pen tip having a smaller contact area than a fingertip at the time of press is valid or a button for determining that an input with a fingertip is valid, (2) an application changing a contact area on which a button reacts to in real time, (3) an application changing a gesture function according to a contact area at the time of press, and the like.

The process of correcting the distance between two points in S10 of FIG. 2 will be described below.

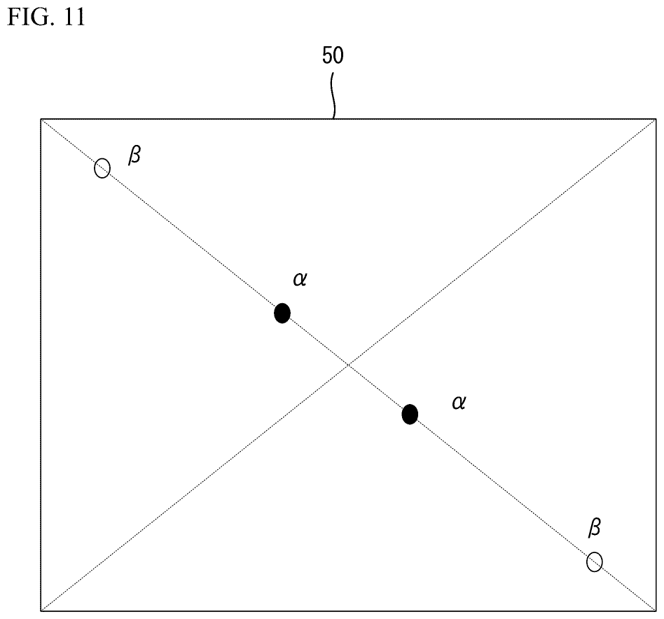

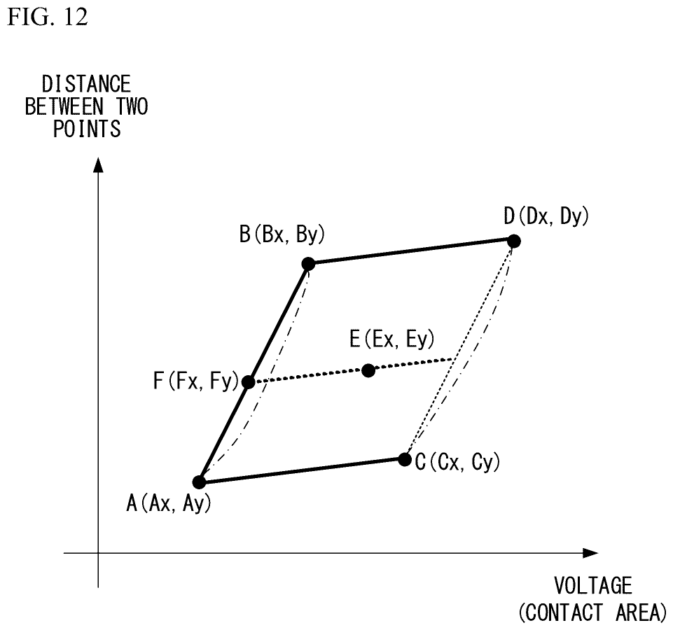

FIG. 11 is a diagram illustrating an example in which a plurality of two-point inputs are displayed on a display device disposed under the touch panel 50. FIG. 12 is a diagram illustrating the relationship between the contact area and the distance between two points when the input points of the two-point input of FIG. 11 are pressed. Although the X axis and the Y axis in FIG. 12 indicate the contact area and the distance between two points, respectively, the Y axis and the X axis in FIG. 12 may indicate the contact area and the distance between two points, respectively.

In FIG. 11, two points α and two points β are displayed as input points of the two-point input on the display device disposed under the touch panel 50. The two points α and the two points β are displayed in sequence to prompt a user to perform a touch input. The two points α and the two points β are arranged in the same direction (i.e., an upper left direction in FIG. 11), and a distance between two points β is larger than a distance between two points α. It is sufficient that the two points α and the two points β are arranged in the same direction, and the two points α and the two points β may be arranged in an upper right direction, a horizontal direction, or a vertical direction in FIG. 11.

The contact area and the distance between two points when the two points α in FIG. 11 are input by a pen (first inputter) having a tip of 2 mm in diameter φ correspond to a point A in FIG. 12, and the contact area and the distance between two points when the two points β in FIG. 11 are input by the pen having the tip of 2 mm in diameter φ correspond to a point B in FIG. 12. The contact area and the distance between two points when the two points α of FIG. 11 are input by a jig (second inputter) having a tip of 22 mm in diameter φ correspond to a point C of FIG. 12, and the contact area and the distance between two points when the two points β of FIG. 11 are input by the jig having the tip of 22 mm in diameter φ correspond to a point D of FIG. 12. The diameter of each of the first and the second inputters is an example, and is not limited to the above-mentioned value.

When two points are input by a finger (third inputter), for example, since the finger has a tip of a diameter of 6 to 15 mm, the contact area of the jig having the tip of 22 mm in diameter is larger than the contact area of the finger, and the contact area of the finger is larger than the contact area of the pen having the tip of 2 mm in diameter. A member having a contact area smaller than the contact area of the finger is not limited to the pen. A member having a contact area larger than the contact area of the finger is not limited to the jig. The third inputter having a diameter larger than that of the pen having the tip of 2 mm and smaller than that of the jig having the tip of 22 mm is not limited to the finger, and may be, for example, a jig having a tip of 10 mm in diameter φ.

In FIG. 12, the distance between two points is calculated in the same manner as in S9 of FIG. 2. The contact areas of each point of the two-point input at the respective points are set to the total value of the voltages Vx2 and Vx1, and the total value of the contact areas of the two points is set to double the total value of the voltages Vx2 and Vx1, as in S28 of FIG. 7.

When two arbitrary points are input while the distance between two points β in FIG. 11 is made closer to the distance between two points α, and the contact area and the distance between two points are plotted in FIG. 12, the curves between the points A and B and between the points C and D in FIG. 12 are actually as illustrated by the alternate long and short dash lines. However, in the present embodiment, by approximating the curve between the points A and B in FIG. 12 by a straight line, the calculation of a correction equation and a correction method, which will be described later, can be facilitated, and the processing load of the CPU 31 can be reduced.

A point E in FIG. 12 indicates the contact area and the distance between two points when two points are input by the finger. As illustrated in FIG. 12, even if the same two points (for example, two points α and two points β) are input, when the contact area of the two points is large, the distance between two points becomes larger than the actual distance, and the input coordinates of the two points are deviated from the actual coordinates of the two points. Therefore, in the present embodiment, the CPU 31 generates a straight line EF that passes through the point E in FIG. 12 and is parallel to a straight line AC or a straight line BD as a correction formula, and corrects a distance between two points (i.e., the distance between two points of the point E) when two points are input by the finger to a distance between two points of an intersection point F between the correction formula and the straight line AB. This correction can suppress the distance between two points when two points are input by the finger from becoming greater than the actual distance. That is, the deviation of the distance between two points due to the contact area can be suppressed. Further, since the coordinates of the two points are calculated using the distance between two points as illustrated in S11 of FIG. 2, the accuracy of the coordinates (input positions) of the two points can be improved.

Assume that the coordinates of the point A in FIG. 12 are (Ax, Ay), the coordinates of the point B are (Bx, By), the coordinates of the point C are (Cx, Cy), the coordinates of the point D are (Dx, Dy), the coordinates of the point E are (Ex, Ey), and the coordinates of the point F are (Fx, Fy).

At this time, the straight line AC is calculated by an equation (5), the straight line AB is calculated by an equation (6), the straight line FE is calculated by an equation (7), and the intersection point F is calculated by an equation (8).

$$STRAIGHT LINE AC Y = \frac{( Cy - Ay ) X + Ay ( C x - A x ) - A x ( Cy - Ay )}{Cx - Ax} \qquad ( 5 )$$

$$STRAIGHT LINE AB Y = \frac{( B y - A y ) X + A y ( B x - A x ) - A x ( B y - A y )}{B x - A x} \qquad ( 6 )$$

$$STRAIGHT LINE FE Y = \frac{( C y - A y ) X + ( C x - A x ) E y - ( C y - A y ) E x}{C x - A x} \qquad ( 7 )$$

$$INTERSECTION POINT F {F}_{x} = \frac{( B x - A x ) ( C x - A x ) Ey - ( Bx - Ax ) ( Cy - A y ) Ex - Ay ( Bx - Ax ) ( Cx - A x ) + A x ( C x - A x ) ( B y - Ay )}{( Cx - Ax ) ( By - Ay ) - ( B x - Ax ) ( Cy - Ay )} \qquad ( 8 )$$

$${F}_{y} = \frac{( By - Ay ) \{ ( Bx - Ax ) ( Cx - A x ) E y - ( B x - Ax ) ( Cy - A y ) E x - A y ( B x - Ax ) ( Cx - A x ) + A x ( C x - Ax ) ( By - Ay ) \}}{( Bx - Ax ) \{ ( Cx - Ax ) ( By - Ay ) - ( B x - A x ) ( Cy - Ay ) \}} + Ay - \frac{( B y - Ay ) Ax}{B x - A x}$$

The straight line BD may be used instead of the straight line AC. In this case, the straight line BD is calculated by an equation (9), the straight line AB is calculated by the equation (6), the straight line FE is calculated by an equation (10), and the intersection point F is calculated by an equation (11).

$$STRAIGHT LINE BD Y = \frac{( D y - B y ) X + B y ( D x - B x ) - B x ( D y - B y )}{D x - B x} \qquad ( 9 )$$

$$STRAIGHT LINE FE Y = \frac{( Dy - By ) X + ( D x - B x ) E y - ( D y - B y ) E x}{D x - B x} \qquad ( 10 )$$

$$INTERSECTION POINT F {F}_{x} = \frac{\begin{matrix}( B x - A x ) ( D x - Bx ) Ey - ( Bx - A x ) ( D y - B y ) Ex - \\ Ay ( Bx - Ax ) ( Dx - B x ) + A x ( D x - B x ) ( B y - Ay )\end{matrix}}{( Dx - Bx ) ( By - A y ) - ( B x - A x ) ( D y - By )} \qquad ( 11 )$$

$$Fy = \frac{( By - Ay ) \{ ( Bx - Ax ) ( Dx - Bx ) Ey - ( Bx - Ax ) ( Dy - By ) Ex - Ay ( Bx - Ax ) ( Dx - Bx ) + Ax ( Dx - Bx ) ( By - Ay ) \}}{( B x - Ax ) \{ ( Dx - B x ) ( B y - Ay ) - ( Bx - A x ) ( D y - By ) \}} + Ay - \frac{( By - A y ) A x}{B x - A x}$$

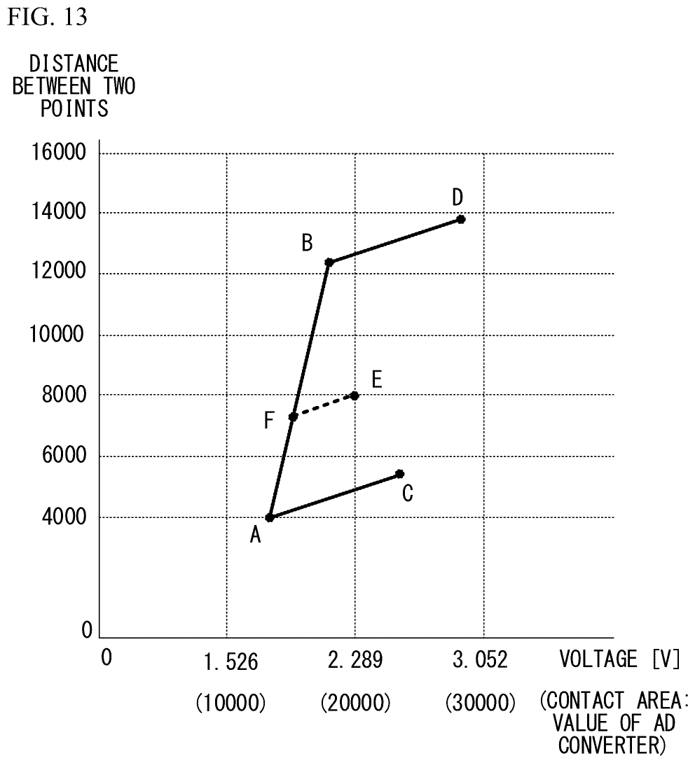

An example of actual simulation is illustrated in FIG. 13. FIG. 13 is a diagram illustrating a relationship between the contact area and the distance between two points when the input points of the two-point input of FIG. 11 are pressed.

In the simulation, the upper left corner of the touch panel 50 is set as an origin (0, 0), and the lower right corner is set as maximum coordinates (16383, 16383). The power supply voltage Vcc is set to 5 V, and a 14-bit AD converter is employed as the voltage measurement units ADX1, ADX2, ADY1, and ADY2. Since the contact area of each point is the total value of the voltages Vx2 and Vx1, the possible range of the contact area of each point is 0 to 32766 (twice as large as 3 fffh=16383). Since the total value of the contact areas of the two points is twice the total value of the voltages Vx2 and Vx1, the possible range of the total value of the contact areas of the two points is 0 to 65532. In this case, the value of the contact areas of the two points can be converted into a corresponding voltage value by an equation (12).

$$VOLTAGE VALUE ( V ) = \frac{CONTACT AREA OF TWO POINTS ( AD VALUE )}{2 \times 2 \times 16383} \times 5 ( V ) \qquad ( 12 )$$

In the simulation, the straight line EF passing through the point E and parallel to the straight line AC or the straight line BD was generated as a correction formula, and the distance between two points and the contact area of the two points of the intersection F between the correction formula and the straight line AB were measured. The results of the simulation are illustrated in Table 1.

TABLE 1

| | | VOLTAGE (V) | |
|---|---|---|---|
| | CONTACT AREAS | CORRESPONDING | DISTANCE |
| | OF TWO POINTS | TO CONTACT | BETWEEN |
| | (AD CONVERTER | AREAS OF | TWO |
| | VALUE) | TWO POINTS | POINTS |
| POINT A | 23316 | 1.779 | 3974 |
| POINT B | 27938 | 2.132 | 12374 |
| POINT C | 33508 | 2.557 | 5432 |
| POINT D | 38130 | 2.909 | 13832 |
| POINT E | 30000 | 2.289 | 8000 |
| POINT F | 25150 | 1.919 | 7306 |

From the results of the simulation, the distance between two points (i.e., the distance between two points of the point E) when the two points are input by the finger is 8000, and the distance between two points (i.e., the distance between two points of the point F) when the two points are input by the pen having the tip of 2 mm in diameter φ is 7306. Therefore, it is understood that when the distance between two points of the point E is corrected as the distance between two points of the intersection point F, about 8.7% (=1−7306/8000) of the actual measured value can be reduced. Therefore, it is possible to suppress the distance between two points when the two points are input by the finger from becoming greater than the actual distance. That is, the deviation of the distance between two points due to the contact area can be suppressed.

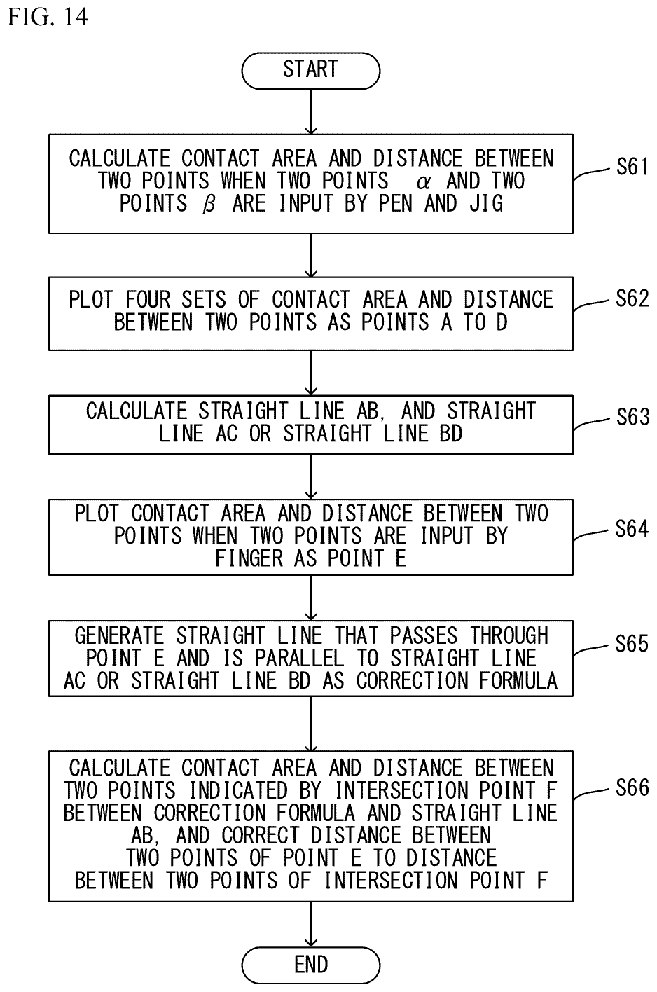

FIG. 14 is a flowchart illustrating the process of correcting the distance between two points in S10 of FIG. 2. As a premise, the computer 40 displays two points α and two points β as input positions of two-point input on the display device disposed under the touch panel 50 as illustrated in FIG. 11.

The CPU 31 calculates the contact area and the distance between two points when the two points α of FIG. 11 are input by the pen having the tip of 2 mm in diameter φ, the contact area and the distance between two points when the two points β are input by the pen having the tip of 2 mm in diameter φ, the contact area and the distance between two points when the two points α are input by the jig having the tip of 22 mm in diameter φ, and the contact area and the distance between two points when the two points β are input by the jig having the tip of 22 mm in diameter φ (S61). The distance between two points is calculated in the same manner as in S9 of FIG. 2. The contact area of each point of the two-point input is set to the total value of the voltages Vx2 and Vx1, and the total value of the contact areas of the two points is set to double the total value of the voltages Vx2 and Vx1, as in S28 of FIG. 7.

Next, in a coordinate system in which the contact area and the distance between two points are respectively set as the X-axis and the Y-axis or the Y-axis and the X-axis, the CPU 31 plots the contact area and the distance between two points when the two points α calculated in S61 are inputted by the pen having the tip of 2 mm in diameter φ, the contact area and the distance between two points when the two points β are inputted by the pen having the tip of 2 mm in diameter φ, the contact area and the distance between two points when the two points α are inputted by the jig having the tip of 22 mm in diameter φ, and the contact area and the distance between two points when the two points β are inputted by the jig having the tip of 22 mm in diameter φ, as the points A to D, respectively (S62).

The CPU 31 calculates the straight line AB (first straight line) passing through the point A (first point) and the point B (second point), and the straight line AC (second straight line) passing through the point A and the point C (third point) or the straight line BD (second straight line) passing through the point B and the point D (fourth point) (S63). The CPU 31 plots the contact area and the distance between two points when the two points are input by the finger as the point E (fifth point) (S64). The two points inputted by the finger are two points freely selected, and may be other than the two points α and the two points β, or may be the same as the two points α or the two points β.

The CPU 31 generates the straight line (i.e., straight line EF in FIG. 12) that passes through the point E and is parallel to the straight line AC or the straight line BD as the correction formula (S65). The CPU 31 calculates the contact area and the distance between two points indicated by the intersection point F between the correction formula and the straight line AB, and corrects the distance between two points of the point E as the distance between two points indicated by the intersection point F between the correction formula and the straight line AB (S66), and ends the process.

As described above, based on the contact area and the distance between two points of two-point input by each of a plurality of inputters (for example, the finger, the pen having the tip of 2 mm in diameter φ and the jig having the tip of 22 mm in diameter T), the CPU 31 corrects the distance between two points when the two points are input by one (for example, the finger) of the plurality of inputters having a tip with a diameter larger than the diameter of the tip of another (for example, the pen having the tip of 2 mm in diameter φ) of the plurality of inputters and smaller than the diameter of the tip of the other (for example, the jig having the tip of 22 mm in diameter φ) of the plurality of inputters to the distance between two points when two points are input by the another (for example, the pen having the tip of 2 mm in diameter φ) of the plurality of inputters. This makes it possible to suppress the distance between two points when the two points are input by the one (for example, the finger) of the plurality of inputters from becoming greater than the actual distance. That is, the deviation of the distance between two points due to the contact area can be suppressed. Since the coordinates of the two points are calculated using the distance between two points, the accuracy of the coordinates of the two points can be improved.

Since the correction formula is generated using the contact area of the two points and the distance between two points when the input is made by the pen having a contact area smaller than the contact area of the finger and the jig having the contact area larger than the contact area of the finger, the inclination of the correction formula is more appropriate than that of the correction formula in the case where only the pen having the contact area smaller than the contact area of the finger is used or only the jig having the contact area larger than the contact area of the finger is used, and the correction formula can be generated that can make the distance between two points when two points are input by the finger closer to the actual distance.

All examples and conditional language provided herein are intended for the purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A touch panel including a first resistive film having a first electrode and a second electrode provided at both ends in a first direction, and a second resistive film having a third electrode and a fourth electrode provided at both ends in a second direction perpendicular to the first direction, the touch panel detecting contact between the first resistive film and the second resistive film caused by pressing the first resistive film, and outputting a pressed position, the touch panel comprising:
a first detector that detects a contact area between the first resistive film and the second resistive film in pressing the first resistive film;
a second detector that detects a distance between two points when the two points are pressed on the first resistive film; and
a corrector that corrects a detected distance between the two points in accordance with a detected contact area.

2. The touch panel according to claim 1, further comprising:
a plurality of switches connected to the first to fourth electrodes; and
a measurer that controls the plurality of switches so as to apply a voltage to the first electrode and the second electrode and ground the third electrode, measures a first voltage value applied to the fourth electrode, controls the plurality of switches so as to apply a voltage to the first electrode and the second electrode and ground the fourth electrode, and measures a second voltage value applied to the third electrode;
wherein the first detector includes a determiner that determines, when two points are pressed on the first resistive film, a value twice the total of the first voltage value and the second voltage value as a value corresponding to a contact area of the two points,
the second detector includes a calculator that controls the plurality of switches so that the first electrode is at a high potential and the second electrode is at a low potential, applies a voltage to the first resistive film through a first voltage dividing resistor, measures a first direction voltage applied to the first resistive film in the first direction when the two points are pressed, controls the plurality of switches so that the third electrode is at a high potential and the fourth electrode is at a low potential, applies a voltage to the second resistive film through a second voltage dividing resistor, measures a second direction voltage applied to the second resistive film in the second direction when the two points are pressed, and calculates the distance between the two points based on the first direction voltage and the second direction voltage, and
the corrector corrects, based on the contact area of the two points and the distance between the two points when the two points are pressed by each of a plurality of inputters having different diameters of the tips, the distance between the two points when the two points are pressed by one of the plurality of inputters having a tip with a diameter larger than a diameter of a tip of another of the plurality of inputters and smaller than a diameter of a tip of the other of the plurality of inputters to the distance between the two points when the two points are pressed by the another of the plurality of inputters.

3. The touch panel according to claim 2, wherein
the plurality of inputters include a first inputter having a tip with a first diameter and a second inputter having a tip with a second diameter larger than the first diameter,
the one of the plurality of inputters is a third inputter having a tip with a third diameter larger than the first diameter and smaller than the second diameter,
the corrector generates a correction formula for correcting the distance between the two points when the two points are pressed by the third inputter, based on the contact area of the two points and the distance between the two points when the two points are pressed by the first inputter, and the contact area of the two points and the distance between the two points when the two points are pressed by the second inputter, and corrects the distance between the two points when the two points are pressed by the third inputter to the distance between the two points when the two points are pressed by the first inputter, based on the correction formula.

4. The touch panel according to claim 2, wherein
the plurality of inputters include a first inputter having a tip with a first diameter and a second inputter having a tip with a second diameter larger than the first diameter,
the one of the plurality of inputters is a third inputter having a tip with a third diameter larger than the first diameter and smaller than the second diameter,
the contact area of the two points and the distance between the two points when the two points are pressed by the first inputter include a contact area and a distance between the two points of first two points, and a contact area and a distance between the two points of second two points, the second two points being arranged in the same direction as the first two points and having a distance between the two points larger than the first two points,
the contact area and the distance between the two points when the two points are pressed by the second inputter include a contact area and a distance between the two points when the first two points are pressed by the second inputter, and a contact area and a distance between the two points when the second two points are pressed by the second inputter,
in a coordinate system in which the contact area and the distance between the two points are respectively set as an X axis and a Y axis or a Y axis and an X axis, the corrector generates, based on a first straight line that passes through a first point indicating the contact area and the distance between the two points of the first two points when the two points are pressed by the first inputter and a second point indicating the contact area and the distance between the two points of the second two points when the two points are pressed by the first inputter, and a second straight line that passes through the first point and a third point indicating the contact area and the distance between the two points when the first two points are pressed by the second inputter or passes through the second point and a fourth point indicating the contact area and the distance between the two points when the second two points are pressed by the second inputter, a third straight line that passes through a fifth point indicating the contact area and the distance between two points when the two points are pressed by the third inputter and is parallel to the second straight line, as a correction formula, and
the corrector corrects the distance between the two points when the two points are pressed by the third inputter to the distance between the two points indicated by an intersection point between the first straight line and the correction formula.

5. A method for controlling a touch panel including a first resistive film having a first electrode and a second electrode provided at both ends in a first direction, a second resistive film having a third electrode and a fourth electrode provided at both ends in a second direction perpendicular to the first direction, a plurality of switches connected to the first to fourth electrodes, and a controller that controls the plurality of switches, the method for controlling the touch panel comprising:
controlling the plurality of switches so as to apply a voltage to the first electrode and the second electrode and ground the third electrode, measuring a first voltage value applied to the fourth electrode when two points are pressed on the first resistive film, controlling the plurality of switches so as to apply a voltage to the first electrode and the second electrode and ground the fourth electrode, and measuring a second voltage value applied to the third electrode when two points are pressed on the first resistive film;
determining a value twice the total of the first voltage value and the second voltage value as a value corresponding to a contact area of the two points when two points are pressed on the first resistive film;
controlling the plurality of switches so that the first electrode is at a high potential and the second electrode is at a low potential, applying a voltage to the first resistive film via a first voltage dividing resistor, measuring a first direction voltage applied to the first resistive film in the first direction when the two points are pressed, controlling the plurality of switches so that the third electrode is at a high potential and the fourth electrode is at a low potential, applying a voltage to the second resistive film via a second voltage dividing resistor, measuring a second direction voltage applied to the second resistive film in the second direction when the two points are pressed, and calculating a distance between the two points based on the first direction voltage and the second direction voltage; and
correcting, based on the contact area of the two points and the distance between the two points when the two points are pressed by each of a plurality of inputters, the distance between the two points when the two points are pressed by one of the plurality of inputters having a tip with a diameter larger than a diameter of a tip of another of the plurality of inputters and smaller than a diameter of a tip of the other of the plurality of inputters to the distance between the two points when the two points are pressed by the another of the plurality of inputters.

6. A non-transitory computer-readable recording medium having stored therein a program for causing a controller in a touch panel to execute a process, the touch panel including a first resistive film having a first electrode and a second electrode provided at both ends in a first direction, a second resistive film having a third electrode and a fourth electrode provided at both ends in a second direction perpendicular to the first direction, a plurality of switches connected to the first to fourth electrodes, and the controller that controls the plurality of switches, the process comprising:
controlling the plurality of switches so as to apply a voltage to the first electrode and the second electrode and ground the third electrode, measuring a first voltage value applied to the fourth electrode when two points are pressed on the first resistive film, controlling the plurality of switches so as to apply a voltage to the first electrode and the second electrode and ground the fourth electrode, and measuring a second voltage value applied to the third electrode when two points are pressed on the first resistive film;
determining a value twice the total of the first voltage value and the second voltage value as a value corresponding to a contact area of the two points when two points are pressed on the first resistive film;
controlling the plurality of switches so that the first electrode is at a high potential and the second electrode is at a low potential, applying a voltage to the first resistive film via a first voltage dividing resistor, measuring a first direction voltage applied to the first resistive film in the first direction when the two points are pressed, controlling the plurality of switches so that the third electrode is at a high potential and the fourth electrode is at a low potential, applying a voltage to the second resistive film via a second voltage dividing resistor, measuring a second direction voltage applied to the second resistive film in the second direction when the two points are pressed, and calculating a distance between the two points based on the first direction voltage and the second direction voltage; and
correcting, based on the contact area of the two points and the distance between the two points when the two points are pressed by each of a plurality of inputters, the distance between the two points when the two points are pressed by one of the plurality of inputters having a tip with a diameter larger than a diameter of a tip of another of the plurality of inputters and smaller than a diameter of a tip of the other of the plurality of inputters to the distance between the two points when the two points are pressed by the another of the plurality of inputters.
